(19) United States
(12) Patent Application Publication
(10) Pub. No.: US 2007/0153987 A1
(43) Pub. Date: Jul. 5, 2007

(54) Systems and methods for audibly indicating incoming telephone calls

(75) Inventors: Kirk Cameron, Portland, OR (US); John Scheck, Vancouver, WA (US)

Correspondence Address: KOLISCH HARTWELL, P.C., 200 PACIFIC BUILDING, 520 SW YAMHILL STREET, PORTLAND, OR, 97204, US

(73) Assignee: Home Phone Tunes, Inc.

(21) Appl. No.: 11/540,249

(22) Filed: Sep. 29, 2006

Related U.S. Application Data
(60) Provisional application No. 60/756,933, filed on Jan. 5, 2006.

(51) Int. Cl. H04M 1/64

(52) U.S. Cl. 379/67.1

(57) ABSTRACT

A landline-telephone personalization system includes a call indicator device, a computer, and a remote server system. The call indicator device is configured to download audio files from the remote server system and to play one or more of the files to indicate incoming PSTN calls over the landline-telephone connection. The call indicator device may play a first audio file for all incoming calls and a second audio file selected from audio files saved in device memory. The computer of the landline-telephone personalization system may include any conventional computer and may be configured to enable a user to view and select one or more audio files available for download to the call indicator device from the remote server system. The personalization system may save customized audio files at the remote server system. The originator of the files may receive credits when other users download the customized audio file.

### CROSS-REFERENCES

This application claims priority to U.S. Provisional Application Ser. No. 60/756,933 filed Jan. 5, 2006, and entitled “Systems and Methods for Audibly Signaling Incoming Calls,” the entire disclosure of which is incorporated herein by reference for all purposes.

### BACKGROUND

The present disclosure relates generally to devices that play tunes, or audio files, to announce or indicate incoming telephone calls to landline-based telephones. More specifically, the present disclosure relates to devices that download tunes or audio files from a remote server system over a public switched telephone network and that play the downloaded audio files to announce incoming calls.

The telephone plays a central role in many people's lives. It is an important work tool and it is often integral to young people's social lives. Many users have phones near them at nearly all times of the day. These users may want to differentiate their phones and personalize them.

Downloading custom ring tones to cell phones is a very popular way to personalize cell phones. A distinct ring tone allows the users to facilitate the recognition that their phone is ringing. A user also may want to have a distinct ring tone to impress others or for entertainment purposes.

Similar ring tone options currently are not available for home phones using conventional landline telephone systems. Home telephones generally connect to a public switched telephone network (PSTN) via conventional landline telephone lines. Such home telephones are configured to indicate an incoming call through the use of an audible announcement, known as a ring. There are several variations on the home phone rings, short rings, long rings, double rings, etc., but the conventional home phone rings are all variations of the standard jarring ring that has accompanied phones for many decades. The rings used to indicate an incoming telephone call over a landline telephone system are generally not distinctive or customizable. Additionally, conventional home phones, or other phones adapted to receive calls over the landline telephone system, are not capable of downloading audio files to customize the ring, such as is common for cell phones.

Examples of devices that provide some ring tone functionality to phones other than cell phones are found in U.S. Patent Publication Nos. 2004/0109558 A1; 2005/0249336 A1; 2003/0199268 A1; in U.S. patent application Ser. No. 11/445,958 and in UK Patent Application No. GB 2409607. The entire disclosures of these patents and publications are incorporated herein by reference for all purposes.

### SUMMARY

A landline-telephone personalization system includes a call indicator device, a computer, and a remote server system. In a first mode, the call indicator device is configured to download audio files from the remote server system of the landline-telephone personalization system. Audio files are downloaded from the remote server system to the computer. The call indicator device then downloads the audio files from the computer to the call indicator device. In a second mode, the call indicator device connects to the PSTN over the landline telephone connection and plays one or more audio files to indicate incoming calls. Typically, on receiving a call, the call indicator device plays an introductory audio file that is more benign followed by a second audio file to announce the call.

The computer of the landline-telephone personalization system may include any conventional computer and may include components such as a monitor, a keyboard, processors, drives, and other conventional computer features. The computer is adapted to communicate with the remote server system over the Internet. The computer is configured to display a web page that enables a user to view, select and initiate download of audio files available from the remote server system to the call indicator device. The remote server system is configured to establish a connection with the computer through an Internet service provider or other means of communicating between two remote computers. The audio file web page and the audio files themselves reside on the remote server system.

A user of a telephone personalization system within the scope of the present disclosure may use the computer communicating with the remote server system through the web page to view the audio files available to the user for download. The user may additionally be able to use the computer to select one or more audio files to be downloaded The remote server system may be configured to record or log the audio files selected by the user and to index the one or more selected audio files to one or more of the user's call indicator devices. The selected audio files may then be downloaded to the indexed call indicator devices.

The remote server system may function to offer audio files created by users for download to other user's call indicator devices. A creator or originator of an original music file records an audio file and saves it to their computer. The creator connects their computer to the remote server system and uploads the file to the server system and the file is saved in the archive. Similar to how other audio files are presented for selection, the original audio files are displayed to users for selection on a web page, and users may download them to their call indicator device. The audio file creator receives credits each time their original audio file is downloaded and may receive some form of reward upon collecting a threshold of credits.

When used to personalize the landline telephone system, the call indicator devices within the scope of the present disclosure are used in association with a landline telephone and connected to the PSTN through a landline telephone line. The call indicator device detects incoming calls from the PSTN to the landline telephone and plays back one or more of the downloaded audio files to indicate the presence of an incoming call.

Call indicator devices may find other uses and be used in other modes as well. For example, a user may separate the call indicator device from the PSTN connection and use the call indicator device to play downloaded audio files as a demonstration for friends.

### BRIEF DESCRIPTION OF THE FIGURES

FIG. 1 is a schematic view of a landline-telephone personalization system for providing customized audible indicators of incoming calls to a landline telephone.

FIG. 2 is a schematic view of a portion of the landline-telephone personalization system of FIG. 1 showing the computer communicating with the remote server system.

FIG. 3 is a schematic block diagram of a call indicator device according to the present disclosure.

FIG. 4 is a flow chart schematically illustrating at least some of the steps in the operation of a call indicator device in a download mode of operation.

FIG. 5 is a flow chart schematically illustrating at least some of the steps in the operation of a call indicator device in a first playback mode of operation.

FIG. 6 is a flow chart schematically illustrating at least some of the steps in the operation of a call indicator device in a first playback mode of operation including a caller ID module.

FIG. 7 is a flow chart schematically illustrating at least some of the steps in a system for crediting an originator of an audio file for the downloading of the original files to a call indicator device.

FIG. 8 is a flow chart schematically illustrating at least some of the steps in the operation of a call indicator device in a second playback mode of operation while not connected to the landline.

FIG. 9 is a schematic view of another implementation of a landline-telephone personalization system including multiple user phones and multiple call indicator devices on one phone line.

FIG. 10 is an exemplary screen shot of a software component viewable on the computer of a landline-telephone personalization system.

### DETAILED DESCRIPTION

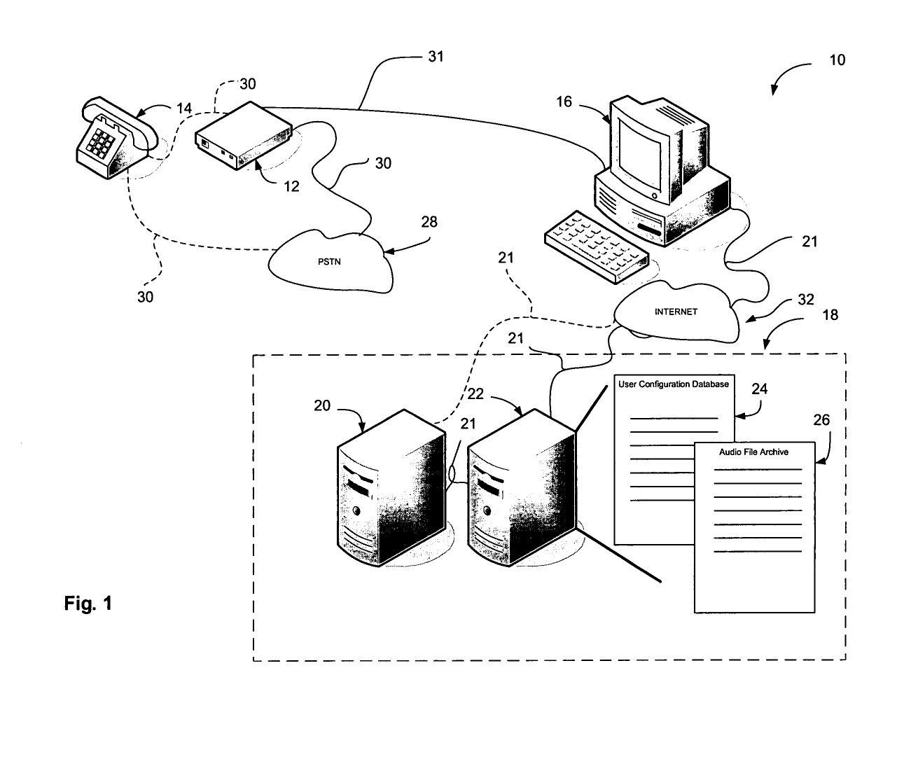

FIG. 1 is a schematic view of a landline-telephone personalization system 10 including a call indicator device 12, a telephone 14, a personal computer 16 and a remote server system 18. Remote server system 18 may include a modem server 20 and an application server 22, as well as other servers and/or components as described herein. The modem server 20 and the application server 22 may be in communication via any suitable communication cable 21 or other communication means. The remote server system 18 may host, or may communicate with computers or servers that host, a user configuration database 24 and an audio file archive 26. The remote server system 18, including the application server 22 and/or the modem server 20, may communicate with the Internet via any suitable communication cable 21 or other communication method.

As illustrated in FIG. 1, the call indicator device 12 communicates with a public switched telephone network (PSTN) 28 via a landline telephone line 30. As used herein, the landline telephone line connection 30 of the call indicator device 12 to the PSTN 28 includes various cables, cords, and other means of connecting the call indicator device 12 to the PSTN 28. However, landline telephone line 30 does not include cellular-type phone connections, Ethernet or broadband connections, or other Internet-based connections that do not pass through a PSTN.

FIG. 1 further illustrates that telephone 14 may be coupled to the PSTN 28 directly through a landline telephone line 30 or may be connected to the PSTN 28 via the call indicator device 12. When connected to the PSTN 28 via the call indicator device 12, the telephone 14 may communicate with the call indicator device 12 via a landline telephone line 30 or through other local communication methods, such as short-range radio, Bluetooth, or other short-range wireless communication means. For example, call indicator device 12 may be provided with the functionality of a telephone in addition to the features described herein and include a wireless transmitter (radio, Bluetooth, or otherwise) to communicate with a telephone 14, a telephone handset, and/or a telephone headset.

Call indicator device 12 and the computer 16 of the present disclosure are configured to operate in a first mode to download audio files from the remote server system. In a second mode, call indicator device 12 and the landline-telephone personalization systems 10 are adapted to operate via a conventional PSTN 28 and play ring tones for incoming calls independently from computer 16. Public switched telephone network 28 may include any or all of the features and equipment customary in conventional public switched telephone networks. PSTN's have served the telephone communication needs of users for many years and have evolved over the years.

The remote server system 18 may include any number of suitable hardware and software components to provide it with the functionality described herein. For example, the application server 22 may include one or more servers and may be adapted to host the audio file archive 26 or to communicate with one or more other servers that host the audio file archive 26. Remote server system 18 may additionally include FTP servers, WWW servers, routers, firewalls, and other components. The number and configuration of the components that comprise the remote server system 18 may vary depending on the number of users, the number of transactions, and/or the complexity of the tasks requested of the remote server system. Accordingly, remote server systems of the present disclosure may be configured in any suitable manner to provide the features and services described herein. Additional features and aspects of the remote server system 18 will become apparent from the additional description provided herein below.

With continued reference to FIG. 1, a computer 16 is illustrated as being connected to the remote server system 18 via the Internet 32, by way of suitable communication cable 21 or other communication method. The computer 16 may be any conventional personal computer or computing device capable of viewing web pages and communicating with remote servers over the Internet 32 or other communication system. For example, computer 16 may include conventional PC's, Mac's, or other computer workstations running one or more operating systems and may also include mobile computing devices adapted to communicate with remote servers over the Internet 32, such as handheld devices, cell phones, etc. As used herein, in a first mode of operation, the computer 16 connects to call indicator device 12 and remote server system 18. Audio files are downloaded to computer 16 and then from computer 16 to device 12. Alternatively, files are downloaded from the remote server system to the device 12 with computer 16 acting as a router or a dumb terminal to facilitate the download.

FIGS. 1-3 illustrate features and aspects of the operation and use of the landline-telephone personalization system 10. In summary, the call indicator device 12 is adapted to operate in at least two modes, a first download mode and a second playback mode. In the second playback mode, the call indicator device 12 is adapted to detect incoming calls over the PSTN 28. Upon detection of an incoming call, the call indicator device is adapted to select one or more audio files from the memory of the call indicator device and play the selected audio files to indicate the incoming call. In the download mode of operation, the call indicator device 12 is adapted connect to computer 16 and remote server system 18 to download one or more audio files from the remote audio file archive 26. The personal computer 16 is used to interact with the remote server system 18 to enable a user to select what audio files will be downloaded to which call indicator devices when the call indicator device operates in the download mode. Computer 16 also provides connections to device 12 and server system 18. Additional details will become apparent in the additional description provided herein.

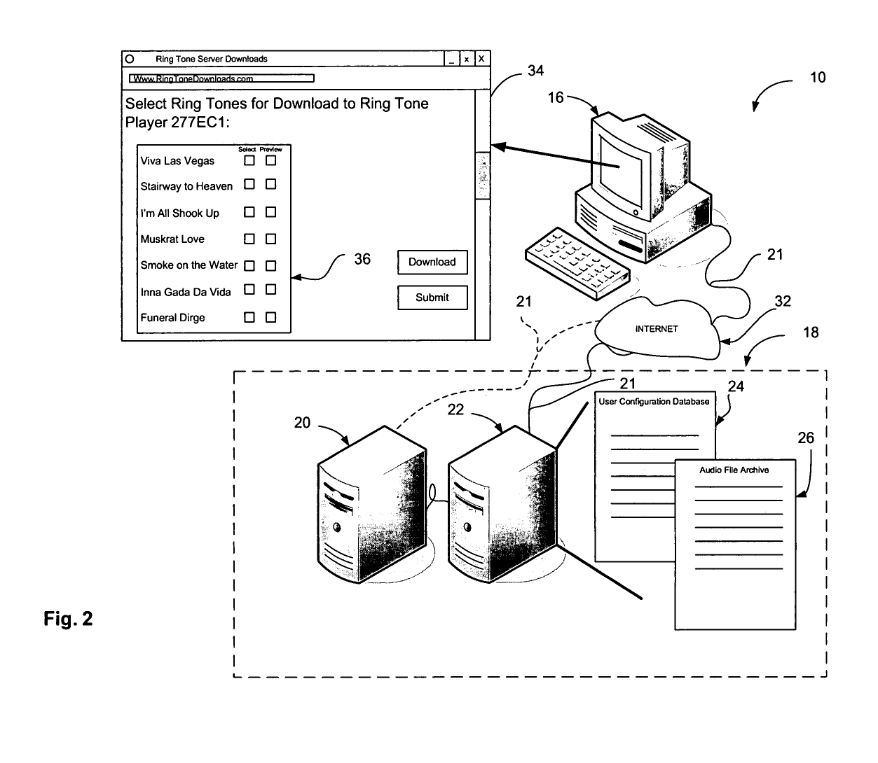

With reference to FIG. 2, portions of the landline-telephone personalization system 10 are illustrated to show the methods through which a user may use the personal computer 16 to interact with the remote server system 18. Specifically, FIG. 2 shows computer 16 connected to remote server system 18 over the Internet 32. The user of the personal computer 16 has accessed a web page 34 from remote server system 18. This web page 34 may be accessed directly using a stand-alone web browser application or may be accessed indirectly by a browser function embedded within the home phone tunes PC software application. In some configurations, the remote server system may include an application server 22 adapted to present web pages to users interacting with the remote server system 18. The application server 22 may be configured to display audio files available for download from the audio file archive 26 to the call indicator device 12.

In some embodiments, the application server 22 may be adapted to present web pages that only display songs that are available for download to a particular call indicator device 12 or to a particular user rather than all audio files that might be available to the remote server system. FIG. 2 illustrates one example of such an adaptation. Web page 34 shown in FIG. 2 indicates that the user has registered Ring Tone Player 277EC1 with the remote server system 18. Prior to viewing the page presented in FIG. 2, the user may have taken steps to register one or more call indicator devices 12, or ring tone players, and/or to establish an account with the remote server system 18, including account preferences and permissions. Web page 34 shows a list of audio files 36 that are available for download from the remote server system 18, and particularly from the audio file archive 26. The web page may present the user with a number of options relative to each audio file, such as to preview the file, select the file for download, purchase the file for download, etc. The list of audio files 36 presented to the user may include all of the files available in the audio file archive 26 or may be limited to a subset by any suitable criteria. For example, a particular user may be limited to a certain subset of available audio files based on their subscription services, the configuration of the call indicator device 12, and/or other factors. Additionally, the web page 34 may enable a user to search for audio files by any suitable criteria, such as artist, genre, title, etc. and the list of audio files 36 may be generated by the results of the search.

Once the user selects one or more audio files for download, the selection may be saved by the remote server system. In some configurations, the selections and information input by the user via the web page 34, such as the call indicator device registration number, the audio file selections, etc., may be saved to the user configuration database 24 hosted by or otherwise accessible by the remote server system 18. User configuration database 24 may store the information in any suitable format that enables suitable referencing and cross-referencing of the input information. The information in the user configuration database 24 may be referenced by and accessible to the user when updating a configuration profile and/or audio file selections. Additionally, the user configuration database 24 and the information therein may be referenced and cross-referenced by administrators of the landline-telephone personalization system 10 in maintaining or operating the remote server system 18.

As described above, the call indicator device 12 may have a first mode of operation wherein the call indicator device is adapted to connect to the remote server system 18 to download audio files. The first mode of operation may also be referred to herein as a download mode of operation. In one configuration, computer 16 may be simultaneously connected to call indicator device 12 and remote server system 18. The server system in this configuration may communicate with the call indicator device, with the computer 16 acting as a passive host. Server system 18 and device 12 may use a handshake protocol that confirms the call indicator device is registered with the server system. The server system 18 may download files to the device 12. The download mode of operation for a given call indicator device 12 may be triggered or initiated by a user. The user initiates and monitors audio file downloads at web page 34.

While operating in the download operating mode, the call indicator device 12 may download a variety of files from the remote server system 18. To enable the remote server system 18 to know what files to download to which call indicator devices, the remote server system 18 may utilize the distinct IP address of the computer 16, the serial number of the device, or some combination of these and/or other device or user identifiers. Upon identifying the user and/or the specific call indicator device, the remote server system 18 may reference the user configuration database to determine what files need to be downloaded to the device. In some configurations, the call indicator device 12 may be configured to send data to the remote server system 18 so the remote server system can determine what files are already on the device and compare that to a database of what should be on the device. The remote server system 18 may then download files to the device, delete files on the device, and otherwise manage the data and files stored on the call indicator device 12. As one example, the remote server system 18 may compare the audio files already saved on the call indicator device 12 with those selected by the user via the Internet interface and the computer 16. The remote server system may then download the songs that were selected to be added and delete the songs that were selected to be deleted. The remote server system and the call indicator device may be configured to delete files on the call indicator device and download new files to the device in any suitable order. For example, there may be a synchronization process where particular files are deleted followed by download of the particular files required to complete the current configuration requirement. Additionally or alternatively, the call indicator device may be configured to be reloaded with each connection so that old files are all deleted or overwritten when the new configuration is downloaded. In some configurations, the call indicator device may be capable of both modes and to automatically or selective operate in one or the other mode depending on the number of changes to be made or upon the user preferences.

Alternatively, all files may be downloaded to computer 16 from remote server system 18. Computer 16 may connect to the server system and may send the serial number or other identification relating to a call indicator device. System 18 or computer 16 may determine what software files are required and which audio files were previously selected for the device. System 18 may download the software and files to the computer and the computer may then be disconnected from remote server system 18. After disconnecting computer 16 from the remote server system 18, call indicator device 12 may connect to computer 16. Device 12 may connect to computer 16 through a cable. Device 12 may connect to computer 16 through a wireless connection. Once connected, computer 16 may download software and audio files previously downloaded from remote server system 18 or generated by user on computer 16 to call indicator device 12.

The remote server system 18 or computer 16 may be adapted to store information about the latest configuration of the call indicator device 12 for troubleshooting the device or for confirming that the user is not selecting more audio files for download than will fit in the storage of the call indicator device. Depending on the status and configuration of the call indicator device, the remote server system 18 or computer 16 may download audio files, firmware updates, programming instructions and indices, or other device configuration files. Additionally, the call indicator device 12 and/or the remote server system 18 or computer 16 may be adapted to validate the files loaded on the device after the download to ensure the integrity of the files.

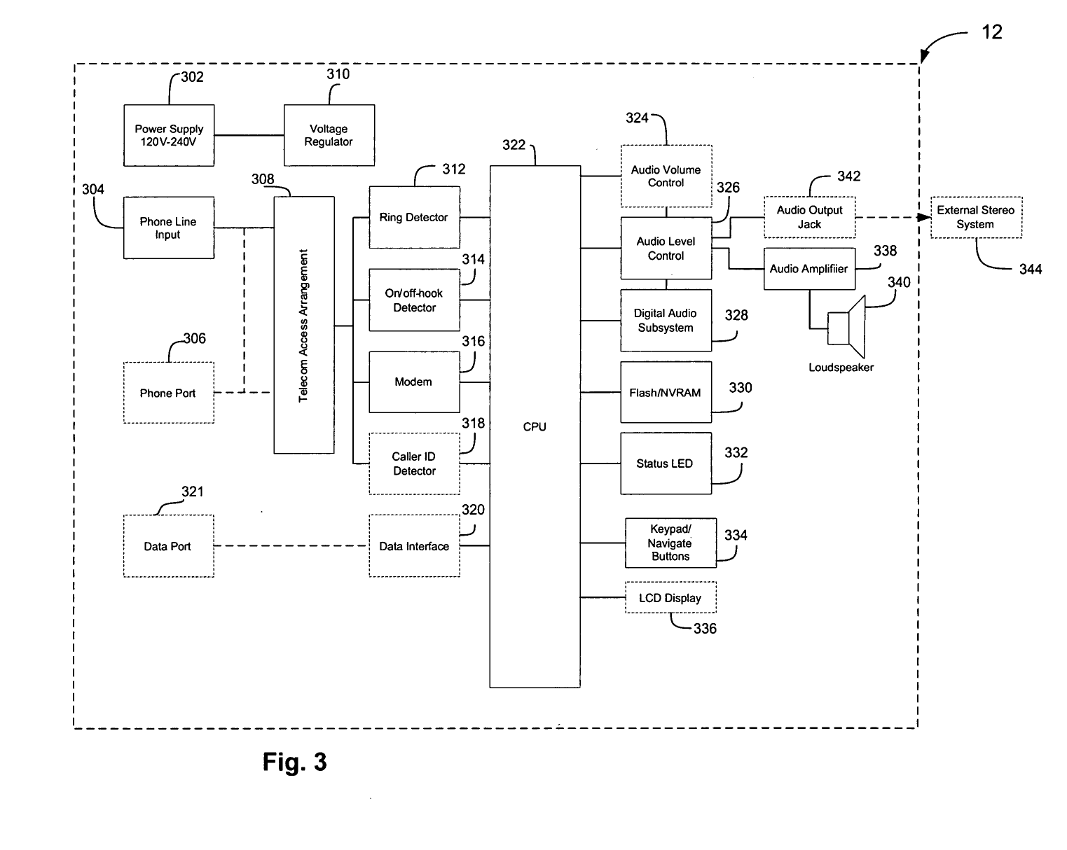

FIG. 3 presents a schematic illustration of an exemplary call indicator device 12. A power supply 302 takes its input power from a standard 120-240 VAC residential power source. Power supply 302 may be auto-ranging where it automatically detects the input voltage and frequency, or it may be designed for a fixed voltage and frequency. Power supply 302 may be external to call indicator device 12 enclosure and connected to device 12 by a low voltage power supply cable. Additionally or alternatively, power supply 302 may be internal to the enclosure of the call indicator device 12 and the cable may be simply a wire or circuit board trace within the device enclosure. A voltage regulator 310 may provide power to components of call indicator device 12 at a variety of voltage levels as required by these components. Other suitable arrangements may be used to provide power to call indicator device 12 or subcomponents thereof. As one example, one or more aspects of call indicator device 12 may utilize some of the low-voltage power provided by the telephone line connection 304 or the data port 321.

Phone line input 304 is a communication port that provides a connection to the incoming telephone line. Optional phone port 306 may be provided to the call indicator device 12 to enable a telephone device to connect the incoming telephone line through the call indicator device 12. The optional phone port 306 may be connected directly to phone line input 304 such that any telephone device connected to the phone port 306 may be able to make and receive calls regardless of whether the call indicator device 12 is powered on or off. The illustrated call indicator device 12 also includes telecom access arrangement 308 that is connected to the phone line input 304 and the optional phone port 306. The telecom access arrangement 308 may be configured to electrically isolate the telephone line from the other components in device 12, which may help to reduce static, feedback, or other undesirable sound effects that otherwise may be passed to the telephone line from the other components of call indicator device 12.

Ring detector 312 is in communication with the phone line input 304 via the telecom access arrangement 308 and is configured to monitor the incoming telephone line for the ring signals sent over the telephone line by the local telephone company. Ring detector 312 communicates with a CPU 322 to provide the CPU 322 with the status of the incoming ring signal, thereby informing the CPU 322 of when a ring signal is present and when it is not, as well as when an incoming ring signal is determined to have stopped. The configuration of the ring detector 312 may vary depending on the other components included in the call indicator device 12. For example, if the call indicator device 12 omits a telecom access arrangement to isolate the telephone line from the other components, the ring detector circuitry and configuration may vary. Additionally or alternatively, the ring detector 312 may be integrated with other components of the call indicator device 12, such as the caller ID detector 318 described below.

Additionally, an on/off-hook detector 314 is in communication with the phone line input 304. Similar to the ring detector 312, the on/off-hook detector 314 may monitor the incoming telephone line. The on/off-hook detector 314 may be adapted to determine if any telephone handsets connected to this telephone line in parallel with the call indicator device 12 are off-hook. The on/off-hook detector is also in communication with the CPU 322 and is adapted to signal the CPU 322 when any handset in parallel with the call indicator device goes off-hook. Accordingly, the on/off-hook detector 314 may be used to signal to CPU 322 that someone has answered the incoming call or is preparing to make an outgoing call. As with the ring detector 312, the circuitry and configuration of the on/off-hook detector 314 may vary according to the other elements included in the call indicator device and may be integrated with other components.

With continuing reference to FIG. 3, the call indicator devices 12 of the present disclosure include a modem 316. The modem 316 may be used to establish a connection with external systems, such as remote server system 18, for the purpose of downloading audio files and/or configuration data from these external systems to the call indicator device directly over a telephone line and the PSTN. The modem 316 may make the connection through a communications port such as phone line input 304. The connection established by the modem 316 may be a TCP/IP connection. Data and files downloaded by the modem 316 are passed to the CPU 322, which may be adapted to verify and store the audio files and configuration data.

The optional caller ID detector 318 monitors the incoming telephone line for the caller ID information that the local telephone company sends at the start of each call. In call indicator devices 12 that include a caller ID detector 318, the caller ID detector gathers this information once received and sends it to the CPU 322 for processing. Call indicator devices of the present disclosure may be adapted to include one or more additional features or capabilities when a caller ID detector 318 is included, such as described in detail below.

Call indicator device 12 further includes data interface 320. The data interface 320 may be used to connect the call indicator device 12 to personal computer 16 or to another device to transfer audio files and configuration data from personal computer 16 to call indicator device 12 and/or for transferring status and configuration data from call indicator device 12 to personal computer 16. This data interface 320 may be a direct wired connection through an optional physical data port 321, such as connections that may be used for Universal Serial Bus (USB), Digital Serial, RS232/488, or some other proprietary wired interface, or it may be a wireless interface such as Bluetooth, WiFi 802.11, or some other standard or proprietary wireless interface. Data interface 320 may receive commands from CPU 322 and pass data and files to/from CPU 322.

CPU 322 may be any of several commercially available processors, such as an Intel 8051 or Motorola MC68; several manufacturers make analogous suitable processors and other processor designs are also acceptable. One or more of the components illustrated in FIG. 3 may be integrated within CPU 322. Additionally or alternatively, CPU 322 may include watchdog timer functions and address/data logic for accessing and communicating with the other devices shown. Several of the functions and operations of the CPU 322 are described in relation to its cooperation with other components. The CPU 322 may include additional features and capabilities depending on the configuration of the call indicator device 12, the arrangement of the components therein, and number and type of components including therein.

An optional external audio volume control 324 may be physically accessible on the outside of the call indicator device 12 enclosure to allow the user to adjust the general audible volume level of the device 12 both upwards and downwards to suit their specific needs. This optional control may be a button or a thumb-wheel or a knob or some other means that changes the volume of device 12. Additionally or alternatively, external audio volume control 324 may communicate directly or indirectly with the CPU 322 and the CPU 322 sets the level of audio output based at least partially on this input signal from the external audio volume control.

An audio level control 326 may directly control the level of audio output. The audio level control 326 receives volume control inputs from the CPU 322 and/or the external audio volume control 324 and audio inputs from a digital audio subsystem 328. The output from the audio level control 326 is fed to the input of an audio amplifier 338, which drives a loudspeaker 340 producing the physical sounds generated by device 12.

An audio output jack 342 may be provided to allow the user to output some or all of the audio signals generated by call indicator device 12 to a separate stereo system or computer audio system 344. Stereo system 344 may be supplied by the user and may provide an increased sound volume or quality than may be available from loudspeaker 340. Audio output jack 342 may be an RCA type plug, a USB port or another component that provides a connection to output audio signals. Audio output jack 342 may be configured to turn off loudspeaker 340 when a plug is mated to it. Alternatively, loudspeaker 340 and stereo system 344 may work simultaneously.

Digital audio subsystem 328 contains the various circuits that decode the digitally stored audio files and convert them to a stream of audio output which can then be amplified by the audio amplifier 338 and played by a loudspeaker 340. Audio level control 326, digital audio subsystem 328, and audio amplifier 338 may be integrated together or integrated with one or more of the other functional blocks within call indicator device 12. One or more of the components of the audio system, such as audio level control 326, the digital audio subsystem, and audio amplifier 338, may be omitted or modified in call indicator devices within the scope of the present disclosure. The components that make up the audio system of the call indicator devices 12 within the scope of the present disclosure, including the audio volume control 324, the audio level control 326, the digital audio subsystem 328, the audio amplifier 338, and the loudspeaker 340, may be configured in a variety of suitable combinations and may include suitable components from a number of available manufacturers. A suitable combination of components will receive a digital audio file from the CPU 322 or a memory source and will decode the digital audio file into an audio output stream that can be played by a speaker to be heard by a user. Additional features and/or functions may be added but are not required.

A flash/NVRAM 330 provides non-volatile memory for call indicator devices 12 and may contain the user's preloaded or downloaded configuration and audio files in a digital format. In some embodiments of call indicator devices 12, at least a portion of flash/NVRAM memory 330 may be removable by the user. For example, device 12 may have a socket into which a user can insert memory. Additionally or alternatively, all of the non-volatile memory 330 may be encased in the call indicator device 12 and not removable and upgradeable by the user. Moreover, in other embodiments, some or all of memory 330 for a call indicator device may include a battery backed RAM or ROM device, either removable or fixed. A removable Flash/NVRAM, if used, may be one of the several standard and commercially available formats (Compact Flash, SmartMemory, Memory Stick, etc.) commonly used in digital cameras and other electronic devices.

A status LED 332 may be connected to and controlled by the CPU 322. The status LED 332 may comprise a plurality of LEDs of different colors controlled such that the different colors represent different states of device 12. For example, a solid green color may indicate power-on-on-hook, a flashing green may indicate the ringing of an incoming call, a yellow color may indicate that one or more telephone handsets is off-hook, a solid red color may indicate a failed power-on self test, and a blinking red color may indicate an error in programming when connected to a personal computer or remote server, etc. The status LED 332 may communicate with the CPU 322 to receive its control signals.

Multiple LED's and/or alphanumeric displays may be incorporated in call indicator device 12. As illustrated schematically in FIG. 3, an optional LCD Display 336 may be located on an external portion of the enclosure to allow call indicator device 12 to provide text and/or numeric information to the user of device 12. The LCD Display 336 may be in communication with the CPU 322, which may determine what messages are displayed and when these messages are displayed.

FIG. 3 also schematically illustrates that call indicator devices 12 within the scope of the present disclosure may include keypad/navigate button(s) 334, which may be disposed externally on device 12 enclosure to allow the user to provide inputs to the call indicator device 12 and to control the device's function. User inputs to the keypad/navigation button(s) 334 may be sensed by CPU 322 which may then determine the appropriate control function to execute based on the specific inputs provided. In some embodiments, keypad/navigation buttons 334 may be adapted to allow a user to configure some or all aspects of device 12's operation directly on device 12. In other embodiments, keypad/navigation buttons 334 may be limited to a single download button adapted to initiate a download routine, such as discussed above.

As discussed above, the audio volume control 324 may include knobs, dials, buttons, or similar user interfaces and may control the output volume without communicating with the CPU 322 or otherwise adjusting the programming of the call indicator device 12. In such configurations, the volume levels adjusted by the audio volume control 324 may affect all audio output by the call indicator device 12. Additionally or alternatively, a software component of the present call indicator devices may provide the means for users to set the overall volume level for device 12. Additionally, the software component may enable a user to set the volume for specific audio announcements to be different than other audio announcements. For example, a call from a known phone number might be announced with a audio announcement that is louder and/or different from the audio announcement that is played when a call from an unknown phone number is received. Similarly, the software component may enable a user to configure the call indicator devices 12 to play audio announcements at one volume level during certain times of the day and lower volume levels during other times of the day, such as when children are sleeping.

FIG. 3 schematically represents one possible configuration of call indicator device 12 with several optional components additionally being represented. Call indicator devices 12 within the scope of the present disclosure may include more or fewer components and/or components that are integrated with other components. A number of suitable components are available to perform each of the functions described schematically above. Call indicator devices 12 within the scope of the present disclosure include any suitable combination of components to provide the functional features described herein.

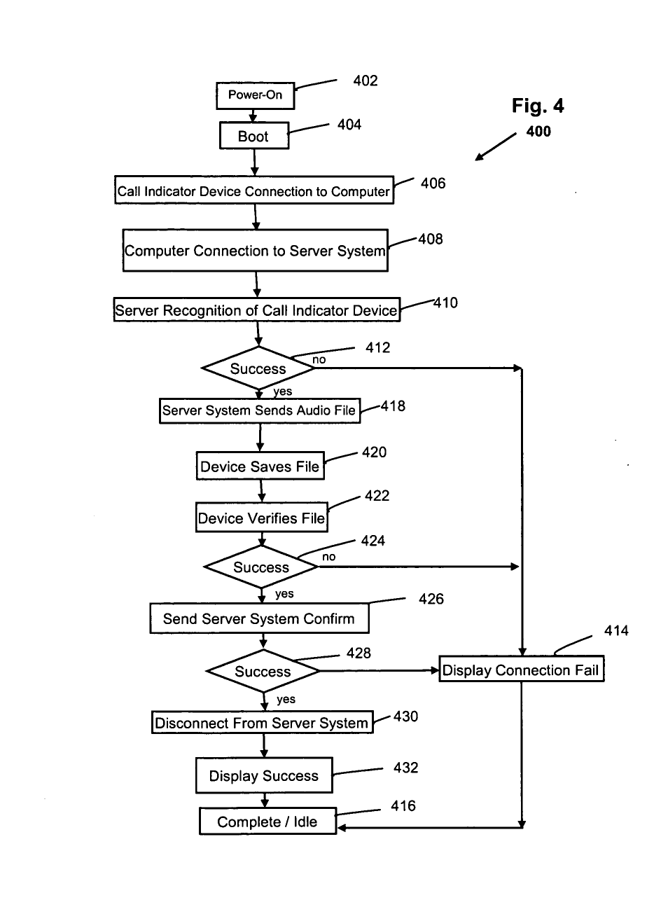

FIG. 4 illustrates a flow chart 400 showing at least some of the possible steps of call indicator device 12 in the first mode of operation, downloading a ring tone file or configuration data from remote server system 18. The initial step 402 is powering on the call indicator device 12. Call indicator device 12 may have a power switch or it may power on when plugged into a power supply. When power is supplied, call indicator device 12 may perform a power-on boot at step 404. After boot, call indicator device 12 may remain in an idle mode and/or a playback mode until the call indicator device is connected to computer 16 at step 406.

The download operating mode may be initiated by computer 16 connecting to remote server system 18. The remote server system 18 and the call indicator device 12 may establish a connection at 408. When device 12 connects to computer 16 and server system 18, a handshake protocol may occur where the device 12 sends identification information such as a serial number to server system 18 at 410. FIG. 4 illustrates at 412 a test step to determine if the connection is successful. If the connection fails at this step or any subsequent step before the audio file or configuration data is successfully transferred, device 12 may enter the display connection fail step 414. In the display connection fail step 414, the call indicator device 12 may set a visual indicator, such as a flashing red LED or some other visual means, to indicate to the user that the audio file or configuration data download was not successful. Additionally, after completing the display connection fail step 414 or executing the step for a predetermined time, call indicator device 12 may reset, and enter the idle step 416 wherein the call indicator device 12 is prepared to enter in to the playback mode.

However, if the connection is successful at the server system recognition of device at step 410, remote server system 18 may determine the correct audio file and/or configuration data to download. The file determination for download may be based on the originating phone number of the call it received, a serial number, an IP address sent from computer 16 to the server system 18, or some other identifier or combination of identifiers. As described above, the remote server system 18 may reference a user configuration database 24 to determine what audio, data, or configuration files are to be downloaded. Additionally or alternatively, the remote server system 18 may receive information from the connected call indicator device to determine what files need to be downloaded, performing a form of synchronization with the remote server system 18. Upon determining what files are to be downloaded to the connected call indicator device 12, the remote server system 18 may begin the transmission of the appropriate files to the call indicator device 12 at 418.

Once the audio files and/or configuration data have been completely received, the call indicator device 12 may enter a file save step 420. During the file save step 420, the CPU 422 may direct the communication between the modem 416 and the memory of the call indicator device to properly store the downloaded files. When the file transmissions step 418 and the file save step 420 are completed, the call indicator device 12 may perform a file verification step 422 in which one or more integrity checks are executed to determine whether the transferred and saved files are complete and saved successfully. The result of the file verification step 422 is illustrated at 424. In the event that the file verification step 422 shows that one or more files are not complete, the call indicator device 12 may enter to the display modem failure step 414, as described above, or an analogous procedure to indicate the failure of the download process. However, if the file verification step 422 indicates that the files transferred were correct and complete, then the call indicator device 12 may enter the send confirmation step 426. In the send confirmation step 426, the call indicator device 12 may communicate back to the remote server system 18 that the files were sent and received successfully.

If this confirmation message from the call indicator device 12 to the remote server system 18 fails to be acknowledged at 428, or if the connection between the call indicator device and the remote server system is otherwise lost, then the device 12 may enter the display modem fail step 414 or another suitable and analogous step to indicate to the user that there was a failure. If the transmission of the confirmation is successful and acknowledged by the remote server system 18, then the call indicator device 12 may disconnect from the server at 430 and transition to the display success step 432. In the display success step 432, the call indicator device 12 indicates the successful completion of the download operating mode through a visual indicator, such as a flashing green LED, or some other visual means, to indicate to the user that the audio file download has been completed successfully. Additionally or alternatively, the call indicator device 12 may indicate the successful completion of the download operating mode by playing a particular audio file. The call indicator device 12 may then reset and enter the complete/idle 416 step in which the call indicator device is transitioned to the playback mode of operation.

FIG. 4 and the above discussion represent one method of communicating between a local call indicator device 12 and the remote server system 18 to download audio files and/or configuration data directly over the telephone line and the PSTN. In alternate steps to those shown in FIG. 4, remote server system 18 downloads audio files to computer 16. Computer 16 in a separate step downloads files to device 12. Device 12 may not be connected to computer 16 when system 18 downloads files. Computer 16 may not be connected to system 18 when files are downloaded to device 12. Some or all of the user configuration database 24 may reside on computer 16 in addition to or in place of it's existence on system 18.

One or more of the logic steps described above may be omitted or removed and additional logic steps may be implemented in configuring systems and methods within the scope of the present disclosure. Some of the possible variations are described herein while other suitable variations are possible.

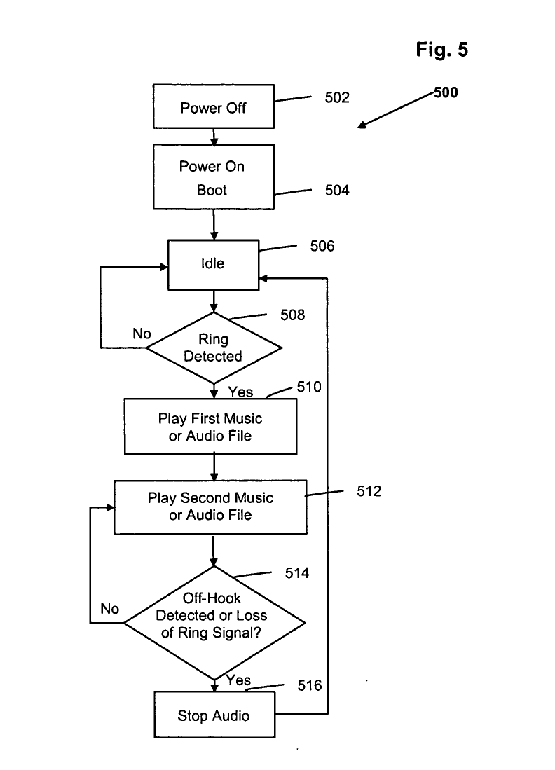

FIG. 5 presents a schematic flow chart 500 showing at least some of the possible steps of a call indicator device 12 according to the present disclosure operating in the second playback mode of operation, in which the call indicator device monitors the telephone line for incoming telephone calls and plays one or more audio files when an incoming telephone call is received. The initial state of device 12 is power off 502, such as when there is no power being supplied to the call indicator device 12 or when the device is turned off. When power is supplied, the call indicator device 12 performs a power-on boot at step 504. The power off, power on, and power-on boot steps described in relation to FIG. 5 may be substantially the same as the analogous steps described above in connection with FIG. 4. Once the call indicator device 12 is turned on, the device may remain in the idle step 506 until a user initiates the download operating mode as described above or until the ring signal of an incoming phone call is detected at step 508. When a ring signal is detected at step 508, the call indicator device 12 may enter a play music/audio step 510. Call indicator device 12 may play a first audio file at step 510 that may serve as an introduction to a second audio file. The first audio file may be a more soothing or softer audio file selected to prepare a listener for a more abrupt or louder second audio file so the listener is not caught off guard. The second subsequent audio file is played at step 512.

The first and second files may be of mixed audio types (e.g. voice/music, music/sound effect, first music genre/second music genre, etc.) The first audio file may be played at a volume that is significantly lower than the volume of the second audio file. For example, the first audio file may be a voice saying in soft tones and at a modest volume, “You have an incoming call.” The second audio file may be a loud and stringent voice at a higher volume saying, “The truth . . . you can't handle the truth!”

During the play music/audio steps 510 and/or 512, the music or audio files are played by the device and may be repeated until either an off-hook condition is detected or a loss of incoming ring signal is detected at step 514. If either of these conditions is met, the call indicator device 12 may move to a stop audio output step 516. In the stop audio output step 516, the call indicator device 12 may stop the audio output, reset itself, and move back into an idle step 506.

FIG. 5 represents a schematic illustration of some of the steps possible in the playback mode of operation. Other suitable steps and features may be provided to the call indicator device 12 during the playback operating mode. As another example of the user of first and second audio files, if the ring signal is detected to stop before a telephone is detected to go off-hook to answer the call, the call indicator device may be configured to play an audio file indicating that the call was missed or that the caller hung up prior to entering the stop audio step 516. Additional or alternative aspects of the playback operating mode are described below and still others may become apparent upon a review of the present application; all such aspects and features are within the scope of the present disclosure.

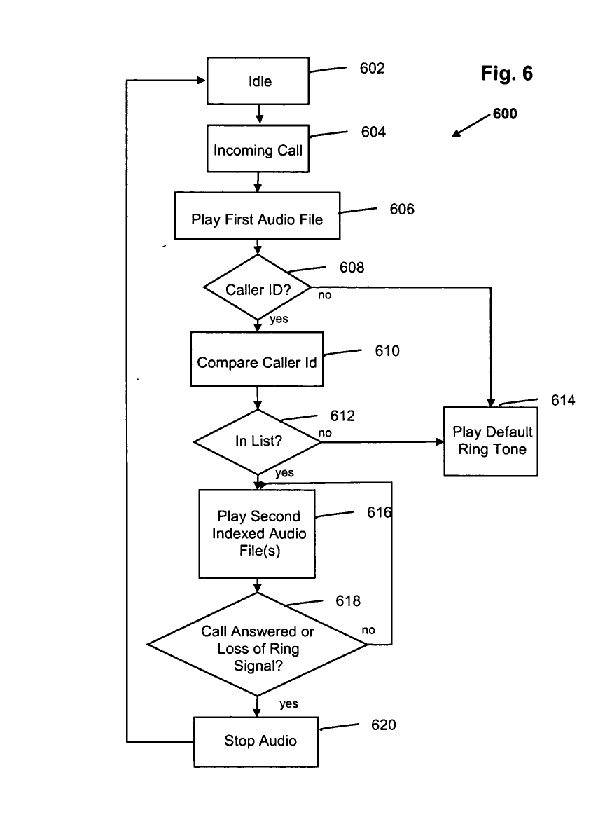

FIG. 6 presents a schematic flow chart 600 for a call indicator device 12 including an optional caller ID detector 318. Call indicator devices 12 that include a caller ID detector 318 may include the capability of reading or determining the calling line ID of an incoming call from the information transmitted by the telephone company when an incoming call is received. The call indicator device 12 may then select one or more particular audio files for playback based at least in part on the determined calling line ID. The schematic flow chart of FIG. 6 shows some possible steps of device 12 in the operation of monitoring the telephone line for incoming telephone calls, determining the calling line ID, and announcing the caller.

Similar to the discussions above, the call indicator device 12 may initially be in a power off state followed by a power-on boot to place the call in an idle state 602. The call indicator device 12 may remain in the idle state 602 until the ring signal of an incoming phone call is detected. Upon detection of the incoming ring signal, the call indicator device 12 may enter the incoming call step 604. At step 606, after the call indicator device detects an incoming call, but before the calling line ID is received from the telephone company, call indicator device 12 plays an initial or first audio file. This may be an audio file that is played for each call and may serve as an introduction to the second audio file. From the incoming call step 604, the call indicator device may receive and read the incoming caller information that is sent by the telephone service provider and use that information to determine the calling line ID, or caller ID, at step 608. The second audio file thus may be selected based on the particular caller ID. If the call indicator device 12 is unable to determine a caller ID from the incoming caller information, the call indicator device may play a default second audio file or ring tone at step 614. The default ring tone may be a randomly selected ring tone, or one that indicates that the caller ID is not known.

Call indicator devices 12 that include an optional caller ID detector 318 may be configured to include a caller audio database that may be stored in the non-volatile RAM or other memory of the call indicator device. The caller audio database may be adapted to associated specific calling line ID's with specific audio files. When a call is received from a given calling line ID included in the caller audio database, the call indicator device 12 plays one or more audio files that were previously identified and associated with the given calling line ID. For example, the calling line ID of a user's mother may be announced by one audio file or set of audio files while the calling line ID of a user's spouse, boss, mother-in-law, etc. may be announced with a different audio file or set of audio files. The caller audio database may be configured by a user at a computer 16 which may or may not be interacting with the remote server system 18. The database constructed by the user at the computer may then be downloaded to the call indicator device directly from computer 16 or from the remote server system 18 along with the audio files and other configuration data. Additionally or alternatively, the call indicator devices within the scope of the present disclosure may include keypads, buttons, controls, displays or other elements to enable a user to locally associate received calling line ID's with audio files already stored on the call indicator device. The locally stored caller audio database may be configured and added to in other suitable manners.

With continuing reference to FIG. 6, the caller ID detector 318, or caller ID module, determines the calling line ID or caller ID at step 608. The call indicator device 12 may then compare the determined caller ID with the caller ID's stored in the local caller audio database to see if there is a match. At 612, if the caller ID of the currently incoming call does not match any caller ID in the caller audio database, then the call indicator device 12 may play a default ring tone or audio file at step 614. Additionally or alternatively, the user may configure the call indicator device 12 to return to the idle state 602 when the incoming caller ID is not found in the caller audio database to screen unwanted calls.

If the caller ID does match one of those in the caller audio database then the call indicator device 12 plays the indexed audio file at step 616. In the play indexed audio file step, the call indicator device 12 may play one or more audio files previously selected by the user and indexed to the caller ID of the currently incoming call. The content of the audio files selected by the user may be customized according to user preferences. In some configurations of the call indicator device 12, the user may be able to select multiple audio files to be played in a particular order or in no order at all. For example, the user may associate a caller ID with a folder of audio files such that an incoming call matching that caller ID would play one or more of the audio files stored in that folder. Additionally or alternatively, the user may associate one or more specific audio files with the caller ID. Additionally or alternatively, one or more caller ID's may be grouped in the caller audio database and associated with the same audio file(s) such that the same audio file selection routine is followed when an incoming call is received from any of those caller ID's.

As indicated above, the audio file(s) played back when a caller ID is found in the caller audio database may include any suitable audio content, including music, spoken announcements, or a combination of the two. The audio files may be recorded locally at the call indicator device 12, may be loaded onto the call indicator device from a computer, and/or may be downloaded from the remote server system 18. Regardless of how the audio file is loaded onto the call indicator device 12 and stored in its memory, the call indicator device 12 may play an audio file including the caller's name, nickname, or some other spoken announcement to indicate the identity of the caller. Additionally or alternatively, the call indicator device 12 may be provided with a text-to-speech functionality that is able to speak the name of the caller as provided in the calling line ID information. In some configurations, the text-to-speech functionality may be configured to play initially followed by an audio file stored on the call indicator device 12.

Referring again to FIG. 6, the call indicator device may remain in the play indexed audio file(s) step 616 until either an off-hook condition is detected or a loss of incoming ring signal is detected, which is indicated at step at 618 as determining whether there is still an incoming call. Additionally or alternatively, the call indicator device may be configured to play a preset number of repetitions in the play indexed audio file(s) step before entering the stop audio step. As one example, a user may want to configure the call indicator device to only announce the incoming call for three repetitions of the indexed audio file(s) or for the number of repetitions necessary announce the call for one minute before silencing the call to no longer disturb the user.

When the incoming ring signal is no longer detected, when there is an off-hook condition detected, or when the predetermined maximum repetitions is reached, the call indicator device may enter a stop audio output step 620. In the stop audio output step 620, the call indicator device 12 may stop all audio output, reset itself, and move back into the idle state 602.

As indicated above, the audio files played by the call indicator device may be loaded onto the call indicator device in a number of suitable manners, such as downloaded from the remote server system 18, imported from a computer, or locally recorded at the call indicator device 12. For pre-recorded music or audio files, the user may download the audio file from the remote server system 18 or may import from a computer, such as by using the data port 321 discussed above.

Additionally, the user may be able to create customized audio files for download or import to the call indicator device 12. For example, a user may be able to create a custom audio file using a computer or some other means and then upload that custom audio file to the remote server system 18 for download to the call indicator device 12. Additionally or alternatively, the custom audio file created on the computer may be imported to the call indicator device through a more direct connection to the call indicator device 12. The remote server system 18 may additionally or alternatively provide an interface for a user at computer 16 to customize a pre-recorded audio file stored at the remote server system for later download to call indicator device as a customized audio file, such as by adding speech over music or mixing two or more songs or audio files. Additionally or alternatively, call indicator devices 12 within the scope of the present disclosure may be adapted to enable the user to locally record an audio file, including music and or speech, at the call indicator device 12 and associate the locally recorded file with one or more caller ID's. For example, the user may use a microphone built in to the call indicator device 12 or the call indicator device may be adapted to selectively record sounds spoken into an attached telephone handset. Through the use of visual displays and user interfaces and keypads, the user may be able to assign a file name to the locally recorded audio file and associate the file name with one or more caller ID's for storage in the caller audio database.

A user may create original audio files for use with a call indicator device. The created audio files may be original music, remixed music, poetry, spoken words or some combination. The originator of the customized audio files may want to make the customized audio file available to other call indicator device users as part of a rewards system. With the customized audio file saved on computer 16, the originator connects computer 16 to remote file server system 18 using web page 34. The remote server system 18 is configured to upload audio files from users. The audio file web site 34 provides the functionality for the originator to identify the customized audio file saved on computer 16 and upload it to remote server system 18. The original audio file is saved to the archive. Original audio files may be shown on a web page separate from non-original or standard audio files. The web page may display the originator's picture or a profile. There may be a link on the web page associated with the originator that goes to a web page not associated with the remote server system 18 such as a personal web page. When the audio file is displayed on the remote server system web page it may become available as a file selection to other users. Users may be able to preview the original audio file on their computer before selection and downloading. The customized file also may be indexed to the originator on upload. When users download the customized audio file indexed to the originator, the originator may be assigned credits, and may be rewarded in response to accumulated credits.

For example, upon collecting a specified quantity of credits, an originator may receive a reward of free downloads from the remote file server system 18. Alternatively or additionally, the originator may receive a cash reward based on the credits accumulated, or based on the number of downloads of the originator's work(s).

In some embodiments, call indicator device 12 will only play audio files downloaded from remote file server system 18. Files may be coded or configured so device 12 only recognizes files downloaded from the server as compatible files. This may prevent users from unauthorized sharing of audio files, or from uploading audio files directly from a computer 16 to the call indicator device 12 without controlling participation of server system 18.

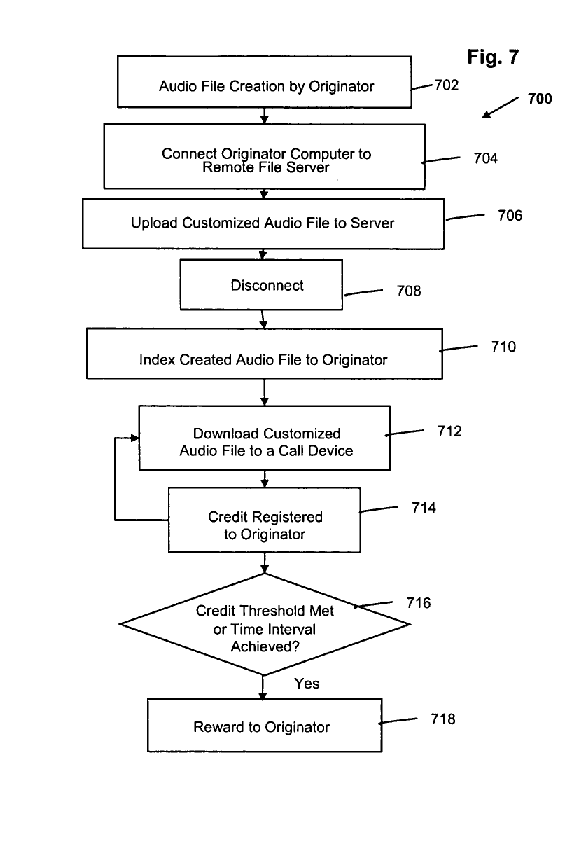

FIG. 7 presents a schematic flow chart 700 showing at least some of the possible steps of a file originator loading and registering a customized audio file in a remote server system 18. At step 702 an audio file is created by a user originator. The audio file may be created by any means. The audio file may combine several files downloaded from remote server system 18. The audio file may additionally or alternately comprise speech or other audio originating with the user themselves. Content of the customized audio file is limited only by the originator's creativity and any file size or other capacity limits the system may impose. To upload the file to the server system, the user originator connects a computer with the customized file to the remote server system 18 by logging onto the web site 34 or other connection means at step 704. The originator logs into the server holding identification information that allows server system 18 to index audio files created by the originator and to recognize the user at the next login. At step 706 the original audio file is uploaded to the server system from computer 16 and the file is indexed to the originator for continued reference. Web page 34 may be configured to have the user browse to the directory and file name under which the customized file is saved on computer 16 and upload the file to the audio file archive. At step 708 the user logs out and disconnects the computer from the server system. After being saved and registered to the originator, the customized file is made available to some or all users of the landline-personalization telephone system 10. Users logging on to the server system and viewing web page 34 may be able to access customized audio files and download them to their call indicator devices 12 at step 712. Each time a customized audio file is downloaded at step 712, the originator of the audio file registered in the remote server system 18 may receive a credit at step 714. The credit may be a simple count or the credit may be a cash allowance or other itemization related to the number of downloads. At selected time intervals, or when a selected number of credits are accumulated at 716, the originator may be rewarded at step 718. The reward may take any of a variety of different forms. The reward may be a cash award, purchase credits or the reward may allow the originator to download audio files at no charge from server system 18. The reward may also include publishing the originator's picture on a recognition web page.

These process steps are examples for illustration and should not be construed as a limitation. The actual process may have more steps, fewer steps, a different order or different steps that perform a similar function and still be within the scope of this disclosure.

Call indicator devices 12 according to the present disclosure may be utilized to provide audio-based announcements, in conjunction with alarm clock functionality, to occur at user-selectable times of the day. In call indicator devices featuring this alarm clock functionality, the call indicator device 12 may be configurable by a user to provide an audible alarm of the user's choosing. This “alarm clock” functionality may be provided by call indicator device 12 as an added functionality to the incoming telephone call announcement functionality described above. Additionally or alternatively, a stand-alone alarm clock may be configured with a phone line port for connecting to a PSTN and a modem for establishing connections with the remote server system 18 to allow a user to configure the alarm clock in a manner analogous to the manner described above for the call indicator device 12. For example, the user may interact with the remote server system via a computer 16 to establish a user configuration profile for a particular alarm clock device that then can be downloaded to the alarm clock from the computer or the remote server system. A user may establish a single audio file to be played at all alarm times or may download multiple audio files for selective use for different alarm times.

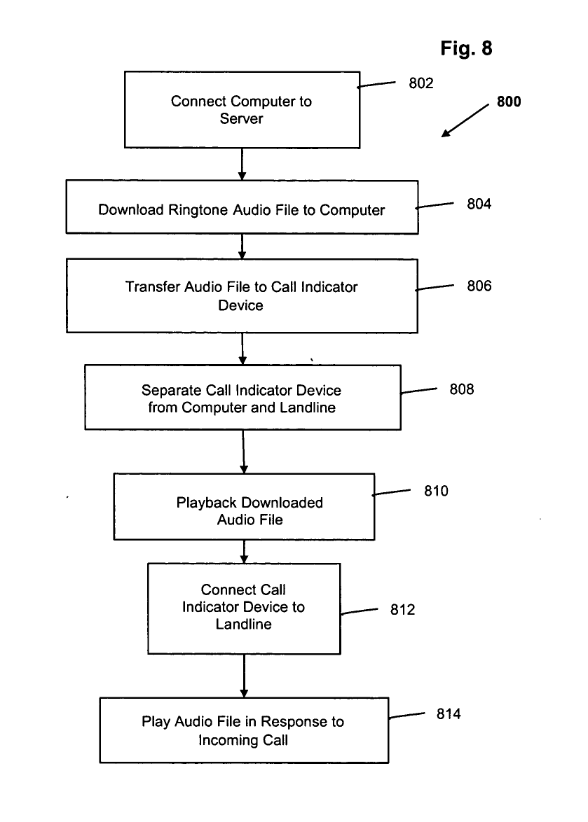

Call indicator device 12 may be used as a player for replaying standard or customized ring tones downloaded from server system 18. A user may create and/or download a customized audio file to announce the identity of a specific caller. The user may wish to demonstrate in person to the potential caller or other friends the ring tone that will announce their call. FIG. 8 shows a flowchart for the use of the device as a ring tone player separate from the landline. At step 802, the user connects computer 16 to remote server system 18. At 804 the user downloads a ring tone audio file from server system 18 to the computer 16 as previously discussed. At step 806 the user transfers the ring tone file to the call indicator device from computer 16, again as previously discussed. At step 808 the user separates the call indicator device 12 from the computer and landline. Device 12 maintains functionality separate from the landline and any other connections. The device may plug into a wall socket for power or may have batteries that supply power separate from a wall socket. The device may have an adapter to allow it to plug into the electrical power supplied by a car. The user plays back the downloaded audio file at step 810 for friends or a potential caller to be identified by the ring tone. At step 812, having completed playing an audio file as a demonstration, the call indicator device may be reconnected to the landline. At step 814, having been returned to service, the call indicator device plays audio files in response to incoming calls.

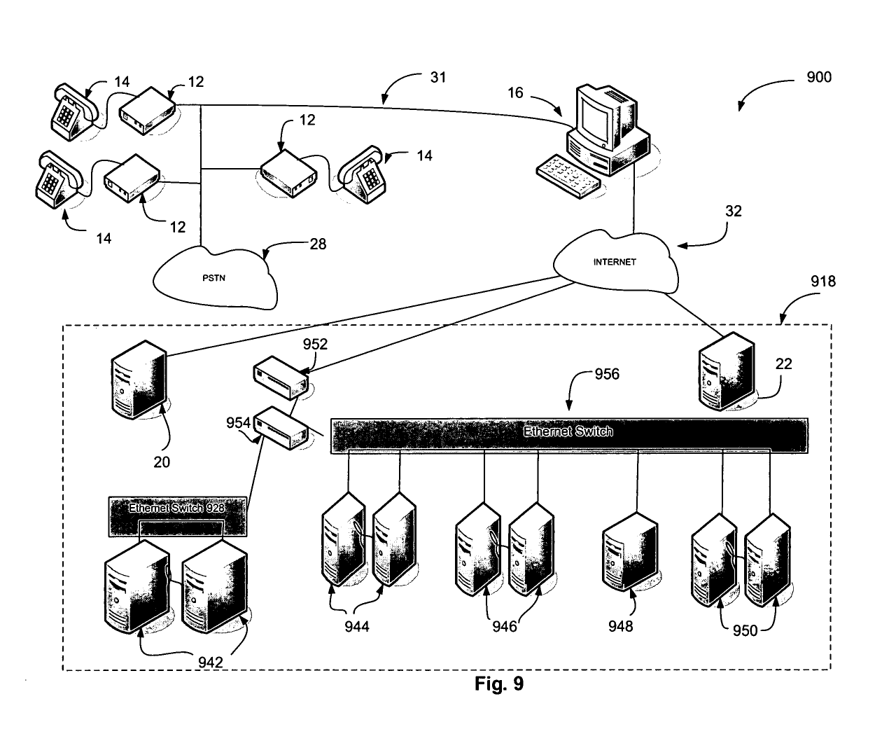

FIG. 9 shows an alternate configuration for a landline-telephone personalization system 900 similar in function to landline-telephone personalization system 10 of FIG. 1. As in FIG. 1, the landline-telephone personalization system 900 may include a computer 16 configured to connect to the Internet 32 through an internet service provider. Similar to the discussion above of FIG. 1, the system further includes three phones 14 and three call indicator devices 12 connected to a public switched telephone network 28 by a single telephone line 30. Call indicator device 12 is connected to computer 16 over connection 31. Connection 31 may exist only to enable the first mode of operation of device 12 in downloading audio files. Connection 31 may be a cable or a wireless connection. Also similar to the discussion of FIG. 1, the remote server system 918 may include a modem server 20 and an application server 22. FIG. 9 illustrates that the remote server system 918 may include additional components, such as one or more world wide web servers 942, one or more FTP servers 944, one or more additional application servers 946, one or more database servers 948, and one or more radius servers 950. The remote server system 918 may also include support equipment such as one or more access routers 952, firewall terminations 954, and ethernet switches 956.

The remote server system 918 may be configured to optimize the operation and maintenance of the entire landline-telephone personalization system 900. As discussed briefly in connection with FIG. 1, the hardware and software configuration requirements of the remote server system 918 may change over time as the landline-telephone personalization system 900 changes, such as changes in the call volume, the number of customers, the number of transactions, or the number of audio files accessible by the remote server system. The remote server system 918 may be a single server with all of the above described functions implemented on the single server. Additionally or alternatively, the remote server system 918 may increase the number of servers over time and different functions may migrate between servers to balance loads. The configurations, methods, and procedures presented here are examples and should not be construed as limitations.

Similar to the above discussion, the user may have acquired one or more call indicator devices 12, each identified by, a serial number, or other unique identifier. The user may access the remote server system 918 and web pages hosted on the web servers 942 through the Internet and an Internet service provider. Through interacting with the web pages, the user may set up an account on the application server 22 referencing the unique identifier of call indicator device 12 or the user may access a previously established account. Once in the account, the user can see the current status of one or more call indicator devices 12, audio files previously selected, and phone numbers indexed to audio files if the call indicator device(s) include the caller ID module. Additionally, through interacting with the web pages, the user may select new audio files for download to the one or more call indicator device and, depending on the configuration of the call indicator device 12, may index audio files and phone numbers to create a caller audio database for each of the one or more call indicator devices. The user configuration data, including account status, current audio file selections, caller audio database, and audio file options may be supported by database servers 948 that store data in a relational database for ease of access and reporting. Additionally or alternatively, the radius servers 950 may provide security features, such as password encryption, userid encryption, and credit card data encryption. Routers 952, firewalls 954, ethernet switches 956, and additional application servers 946 may support various features and functionality to the remote server system, such as access control, purchase and download transaction facilitation and control, and provision of other interactions during user access to the remote server system 918, either via computer 16 or call indicator device 12.

As discussed in connection with both FIGS. 1 and 9, the remote server systems of the present disclosure may include several subcomponents and may change and adapt as the landline-telephone personalization system grows and accommodates more users. Regardless of the configuration of the remote server system, the download procedures and steps may proceed as generally outlined in FIG. 5 and discussed above. Additional or alternatively steps or procedures in the download process may be implemented to enhance the integrity of the system, such as to improve the performance of the call indicator devices and the remote server systems or to improve one or more security aspects of the landline-telephone personalization system. Examples of such additional features, steps, and procedures are described briefly below to illustrate some suitable security or performance measures that implemented in cooperation with the present call indicator devices 12 and remote server systems 18.

As one example of such performance enhancing variations, the remote server system 18 may initiate the download procedure after having a connection established with a call indicator device 12 by sending pre-download configuration instructions to the call indicator device 12. The pre-download configuration instructions may instruct the call indicator device 12 to prepare itself prior to receiving the incoming download file(s). For example, the pre-download configuration instructions may include a series of instructions to move or delete one of more of the audio files that are already stored on device 12, to change configuration settings, or to perform other actions. The user device 12 may perform these changes and then pass back a message to server system 908 indicating that the changes were completed successfully.

The download process may continue with the call indicator device 12 and the remote server system 18 exchanging instructions, requests for instructions, and/or status updates. For example, the remote server system 18 may instruct the call indicator device to download one or more particular audio files, configuration files, firmware files, or other files from one or more servers within the remote server system or in communication with the remote server system. The instructions to the call indicator devices may include instructions regarding the connection protocols to be used, the server IP addresses and connection ports to be used, the logon instructions and passwords, and/or other information and instructions that may be required to download the files. Additionally, the remote server system may instruct the call indicator device what to do with the file once it has been downloaded.

Depending on the number and type of files that need to be downloaded to the call indicator devices 12, the remote server system may queue the downloads to proceed in a particular order with one or more status checks during the download process. For example, in the event that a firmware update is to be downloaded, the firmware update may be downloaded initially, followed by installation of the firmware update, confirmation that the update was installed correctly, and then proceeding with downloading the remaining audio files needed to be downloaded, if there be any. In configurations where the call indicator device 12 and the remote server system 18 exchange and/or transmit periodic status updates during the download operating mode, the status of the download process may be posted or displayed for a user, either through an online interface with the remote server system or through a status display on the call indicator device. In some implementations of the present systems and methods, all of the download instructions may be downloaded from remote server system at one time and then operated upon by the call indicator device at appropriate times, such as one after another or simultaneously, depending on the nature of the instructions. Additionally or alternatively, the instructions may be downloaded step-wise, one after another, as previous instructions are completed. When all of the audio files and update files have been downloaded, the remote server system may send post-download instructions to the user device 12 with final configuration changes as needed. Watchdog timers on the call indicator device 12 may be used to recover from lock-ups and other failures. The final steps in the download operating mode for some call indicator devices 12 within the scope of the present disclosure may include instructions for the call indicator device to send its updated configuration to the server system. When the remote server system 18 stores a record of the current configuration, including the audio files stored on the call indicator device, the user may be better able to modify the configuration via the computer-based interface with the remote server system at computer 16. The current configuration data may also be used in certain security protocols, as described below.

In some configurations of the landline-telephone personalization systems within the scope of the present disclosure, one or more of the call indicator devices 12 and the remote server systems 18 may be adapted to include software and/or hardware to facilitate download session recovery, such as when a session of the download operating mode terminates prior to completing the required steps. For example, the call indicator device and/or the remote server system may log the status of the download session at the time of the failure and be adapted to restart the download operation at that point when the next download session begins.

An operator of the landline-telephone personalization systems according to the present disclosure may be concerned about the security of the remote server system. Additionally, the operators may be concerned about users or others downloading music or other audio files to unauthorized devices or using the audio files in manners beyond the scope of the copyright license granted to the users. A number of security measures may be implemented in different suitable combinations to improve the integrity of the telephone personalization system.

The call indicator devices of the present disclosure may be adapted to use simple algorithms and strings to authenticate the call indicator device attempting to connect with the remote server system. For example, a bitwise XOR of the serial number, or some other secret number permanently stored on device 12, may be compared to an authentication string from remote server system. Additionally or alternatively, the authentication string from the call indicator device may include a dynamic portion that is changed by the remote server system at the end of each download session to be known only by the call indicator device 12 and the remote server system 18. An additional or alternative variation on this algorithm and authentication string security method may include a software function programmed into the call indicator device 12. For example, the call indicator device may be configured to perform one or more operations on a string of characters passed to it by the remote server system at the beginning of the download session and to pass back a computed result that would be compared with the expected value at the remote server system. Using simple algorithms like these or other suitable security configurations may provide several different opportunities to discourage other devices from connecting to service of the present disclosure without proper authentication.

The security of the landline-telephone personalization systems may additionally or alternatively be improved through the use of a login-type procedure for authentication of the call indicator device. In some implementations, the connection between the remote server system 18 and the call indicator device 12 may be configured to require a user id/password login from the call indicator device prior to initiating the download, which may add a layer of security for authentication. An AAA server, such as a Radius server 950 may be incorporated in the remote server system 18 to accommodate and authenticate the many userid/password pairs. The call indicator device 12 attempting to connect to the remote server system may answer the login prompt with the serial number of the call indicator device as the user-id and a password which could be a secret security string stored on device 12, such as the static or dynamic strings described above.

Users of the call indicator devices 12 of the present disclosure will likely want to use the same audio files on multiple call indicator devices that they own, such as one for the family room and one for the bedroom. In some configurations, the user may be required to purchase multiple downloads of the same file or otherwise obtain permission to use the same audio file on two devices. The operator of the present systems and methods may allow unlimited downloads of audio files uploaded by the user but may desire to restrict the downloads of pre-recorded audio files. One simple method of restricting the downloads would be to require the user to register each call indicator device they own with a user account on the remote server system. The user could then have a single-user license to download purchased audio files to all of his/her call indicator devices. The authentication procedures described above could be used to verify that the downloads are only going to devices on the user account.

The systems and methods of the present disclosure may include a software component to facilitate the configuration of call indicator devices 12. The software component may be operated on a computer 16, as discussed above. The software component may be locally installed on the computer 16 or may be provided via a web-based software interface. The software component may be used to create and organize voice and music audio files and announcements, to create and manage a list of caller IDs, and to associate each caller ID or group of caller IDs with one or more voice/music audio files. The software component may provide the ability to easily create customized sound files of spoken names or other recorded audio expressions that can be used to identify the caller in a more personalized or entertaining manner.

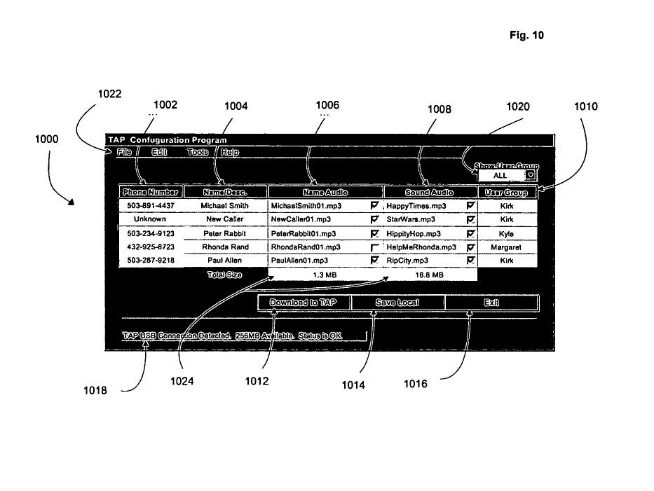

FIG. 10 provides an illustration of a screen shot 1000 of one example of a software component as it might appear on the screen of personal computer 16. The screen shot illustrated in FIG. 10 is one illustration of a user interface to assist the user in creating a caller audio database of caller IDs and desired announcement behavior. The discussion of FIG. 10 along with the remaining discussion of this disclosure illustrates that many other user interfaces and database interfaces may be implemented.

In the illustrated screen shot of FIG. 10, the software component follows the standard software application conventions of providing a main menu across the top of the screen, though other suitable conventions may be implemented. The area below this main menu is a simple grid format in which the user is allowed to edit the cells to create and edit the configuration entries. In addition to allowing the user to directly type data into the cells, the values and file names may be pasted from the standard MS Windows clipboard using MS Windows standard editing functions and may be capable of drag-and-drop placement and specification of these items as well.

With continuing reference to FIG. 10, the Phone Number column 1002 contains a phone number, which may be entered into the field by the user. In some configurations including a caller ID module, the call indicator device may be adapted to upload a list of recent or frequently calling numbers to the remote server system to prompt the user to configure the audio file that will be played when those numbers call again. When programmed into call indicator device 12, the caller ID of the incoming call may be compared with the numbers in this column, and if a match is found, the announcements may be audibly played by device 12 per the associated configuration settings for this matching number. The user may also enter “Unknown” into the rows of this column and proceed with defining how calls from numbers not in the list are to be handled by setting the other attributes for this row on the screen shown. Alternatively, the software component may provide an additional screen where the behavior of the call indicator device 12 is configured for numbers that are not in the database.

The Name/Desc. column 1004 contains a text description that the user gives to the corresponding telephone number. This column can be used to organize and sort the phone numbers by name or description. The Name/Desc. column may also be used for text-to-speech functionality if the user's call indicator device 12 is so equipped. The text-to-speech functionality may use this customized caller name field as the text that is converted to speech rather than the caller ID information sent by the telephone company.

The Name Audio column 1006 contains the name of a digital audio file, which may be the spoken pronunciation of the caller's name as written in the Name/Desc. column and corresponding to the telephone number in the first column. Depending on the manner of implementing the software component, this column may include a link to the location where the audio file is stored and/or may enable the user to upload an audio file to the remote server system for later download to their call indicator device. The user may record the audio contained in this file themselves or may upload other audio content contained on their computers. In one embodiment of the software component, the recording of digital name audio can be done directly through the application software. A computer 16 with a sound card and a microphone can be used to enable a user to record a custom audio file. While the column is labeled Name Audio and may be intended for storage of an audible announcement of the caller's name, users may be able to associate these fields with any suitable audio file, including music files.

The check box in the Name Audio column 1006 may allow the user to enable or disable the playback of this audio when the associated caller calls. Accordingly, the call indicator device 12 may be adapted to play multiple audio files for some callers and fewer audio files for other callers. For example, a user may desire a name announcement and a music announcement for some callers and only a music announcement for other callers. Additionally or alternatively, each row of the grid, and therefore each caller in the caller audio database, may include a field allowing a numeric entry to specify the number of times that the digital audio may be repeated before silencing the call indicator device.

The Sound Audio column 1008 contains the name and/or path of a second digital audio file, which may be played by the call indicator device 12 immediately after the Name Audio file has finished playing. As with the Name Audio column 1006, this column may enable the user to identify where the software can find the designated file, to upload the file to a remote content server, and to otherwise configure the file for synchronization with the call indicator device 12. This second digital audio file may be played repeatedly until either the caller hangs up or the user answers the incoming call. Additionally or alternatively, the second digital audio file specified in the Sound Audio column 1008 and the first audio file specified in the Name Audio column 1006 may repeat in a predetermined or in a random order. The recording and checkbox functionality may be the same as for the Name Audio of the preceding column. The audio files to be played, as designated by the entry in this column, may be enhanced 3-dimensional sounds such as that produced by VR Sound or other enhanced sound technologies which add depth and realism to the audio produced.

The entries in the User Group column 1010 allow the user to group the rows in the grid according to the values entered in this column. One application of the User Group column would be to associate several caller ID entries with a particular user or with a particular instance of call indicator device 12. There may be several instances of call indicator device 12 deployed in a home or other typical implementation and each device may be configured with a different caller audio database according to the callers of interest to the users. For example, the call indicator device in the child's bedroom may have a different set of audio files and callers of interest than the call indicator device located in the home office. Such an implementation would enable a user to silence the phone in the home office for all calls except those from clients and would enable the user to silence the phones in the remainder of the home when the incoming call is from a client. Similar and analogous applications may be desirable by families of different circumstances.

The overall caller audio database managed by the software component of the present disclosure may include the caller audio databases for all of call indicator devices 12 employed by a user or homeowner, with each of the caller audio databases being organized into user groups by the name of the user. When the user chooses to download the caller audio database to a call indicator device 12, such as by clicking the “Download to TAP” button, the user may be prompted to select one of the listed User Groups thereby determining the subset of the caller audio database that is downloaded to the call indicator device 12. This way multiple devices deployed in a household can each be set to respond differently to a particular calling number or to not respond at all.

The software component may provide other methods of configuring multiple devices in a single user group. For example, there may be a master account and several sub-accounts such that each user is able to configure their own lists. Moreover, the sub-accounts may be associated with particular instances of call indicator device 12, such as by associating the sub-account with a device serial number, such that the user's synchronization of call indicator device 12 with the software component may automatically determine which audio files and configuration settings to synchronize.

The “Download to TAP” button 1012 may open a download dialog screen and prompt the user to select one user group from a list of all the possible user groups thereby specifying that the configuration entries for just that particular user group are to be downloaded to a call indicator device. In implementations where the call indicator device 12 connects to the remote server system 18 via the telephone line, the “Download to TAP” button may open a screen for finalizing the configuration settings and preparing the configuration data and audio files for synchronization with call indicator device 12 the next time it is connected to the remote server system 18. The buttons and screens used to finalize the configuration settings and prepare the changes for synchronization with call indicator device 12 may vary. FIG. 10 is one example of an implementation of a software tool for illustration.

The status of the download or synchronization may be displayed to the user confirming a successful download, such as by visual indicators on call indicator device 12 and/or by indicators displayed by the software component. The systems and methods of the present disclosure may be configured to only enable the download or synchronization if the call indicator device 12 is determined to have enough memory to store the selected files and other configuration parameters for download. The determination of the available memory on the device may be made by comparing the selected changes with the last known configuration of the call indicator device stored by the remote server system. Additionally or alternatively, the call indicator device 12 may be instructed to transmit its current configuration to the remote server system at the outset of the download operating mode to confirm that the remainder of the download operation will be able to complete successfully. If there is not enough memory in the call indicator device 12, the user may be instructed to adjust their configuration so that it may fit into the memory space available. The user may be advised of the storage space failure either through the software component or through visual indicators on the call indicator device 12 depending on how the storage capacity is determined. Another option of purchasing and installing additional memory, such as flash memory, may also be presented to the user through the software component.

The “Save Local” button 1014 may open a standard save file dialog screen allowing the user to save the contents of the caller audio database and/or other configuration details to a local file for backup and later retrieval. This essentially stores the configuration files on the user's local PC so they can be used again and/or edited in the future. Similar configuration file save functionality may be implemented in a number of suitable manners. Additionally or alternatively, the user may be able to save the configuration files to the remote server system. Similarly, the last synchronized configuration settings may be automatically saved to a remote server as described above.

The “Exit” button 1016 may cause the software component to close and exit. In implementations including a login functionality, the “Exit” button may additionally log the user off of the software component. If changes have been made to any of the configuration files since the save function was last initiated, the user may be prompted to save these new changes before exiting.

The status bar 1018 at the bottom of the screen may display general status information as well as specific status messages depending upon the action being taken and the context of this action. Some of the typical status messages displayed may relate to the connection from the personal computer 16 to call indicator device 12, the connection from the personal computer 16 to the Internet and the remote server system, the connection from call indicator device 12 to the remote server system, the status conditions and memory capacity of the connected device, and the general status regarding operation of the software component. Other suitable status messages may also be displayed.

The “combo drop-down” control 1020 labeled “Show User Group” may allow the user to display only those rows in the grid where the User Group entry matches the entry herein selected. The purpose of this control is to allow the user to display entries one-group-at-a-time if desired. Similar sorting features may be implemented to sort by other criteria.

The menu 1022 across the top of this screen shows that this software application may have main menu selections of “File”, “Edit”, “Tools” and “Help”. These menus may contain submenus and selections typical for Microsoft Windows based applications that allow the user to save their configurations, edit saved configurations, cut and paste entries from within the application as well as from other external applications and other functions typical to similar applications. Additional menu items and submenu items may be utilized as desired.

As indicated above, FIG. 10 provides a screen shot of an exemplary user interface for a software component that may be provided as part of the present systems and methods. The software component may include additional or different features and/or functionality depending on the configuration of call indicator device 12.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Where the disclosure or subsequently filed claims recite “a” or “a first” element or the equivalent thereof, it should be within the scope of the present inventions that such disclosure or claims may be understood to include incorporation of one or more such elements, neither requiring nor excluding two or more such elements.

Applicant reserves the right to submit claims directed to certain combinations and subcombinations that are directed to one of the disclosed inventions and are believed to be novel and non-obvious. Inventions embodied in other combinations and subcombinations of features, functions, elements and/or properties may be claimed through amendment of the subsequently filed claims or presentation of new claims in that or a related application. Such amended or new claims, whether they are directed to a different invention or directed to the same invention, whether different, broader, narrower or equal in scope to the original claims, are also regarded as included within the subject matter of the inventions of the present disclosure.

We claim:

1. A call indicator device to be used with a remote access file archive, the call indicator device comprising:
a speaker for reproducing audio from audio files;
memory for storing audio files and program instructions;
a processor for executing the program instructions;
a communications port configured to connect to a public switched telephone network (PSTN); and
an electronic circuit operably connected to the communications port and the processor to convert PSTN signals to digital signals;
wherein the device is adapted to operate in a download mode to download an audio file from the remote access file archive to the memory of the device;
wherein the device is adapted to operate in a playback mode to:
detect an incoming PSTN call at the communications port;
select a first audio file and a second audio file from memory;
play the selected first audio file to indicate the incoming call; and
play the selected second audio file subsequent to playing the selected first audio file.

2. The call indicator device of claim 1 wherein the selected first audio file is played for all incoming calls.

3. The call indicator device of claim 1 further comprising a caller ID module configured to determine the calling line ID (CLID) of the incoming call.

4. The call indicator device of claim 3 wherein during the playback mode of operation selection of the second audio file for playback is based at least in part on the determined CLID of the incoming call.

5. The call indicator device of claim 1 wherein during the playback mode of operation the device randomly selects the second audio file.

6. The call indicator device of claim 1 wherein the call indicator device further includes a data port for downloading audio files from a computer where the audio files were previously downloaded from the file archive.

7. The call indicator device of claim 6 where the data port is a USB port.

8. A call indicator device comprising:
a speaker for reproducing audio from audio files;
memory for storing audio files and program instructions;
a processor for executing the program instructions;
a first communications port to connect the call indicator device to a public switched telephone network (PSTN) landline;
a second communications port configured to connect the call indicator device to a computer storing audio files downloaded from a remote audio file archive; and
an electronic circuit operably connected to the first communications port and the processor to convert PSTN signals to digital signals;
wherein the device operates in a download mode to:
connect to the computer through the second communications port; and
download an audio file from the computer to the memory of the call indicator device;
wherein the device operates in a first playback mode connected to a PSTN landline
to:
detect an incoming call;
select at least one audio file from memory as a call indicator; and
play the selected audio file in response to the incoming call;
wherein the device operates in a second playback mode disconnected from the PSTN landline to:
select an audio file for playback; and
play the selected audio file.

9. The call indictor device of claim 8 further comprising a third communications port to output an audio signal of an audio file.

10. The call indictor device of claim 8 where the second communications port is a wireless connection.

11. The call indictor device of claim 8 where the second communication port is a USB port to connect to a USB cable.

12. The call indictor device of claim 8 where the device further operates in the first playback mode to play a first audio file selected from memory and to subsequently play a second audio file selected from memory.

13. A landline-telephone personalization system comprising:
a remote server system configured to:
register an originator of an original audio file;
upload the original audio file to an audio file archive;
index the original audio files to the registered file originator;
present on a web page the original audio files available for selection and download; and
download at least one audio file selected from the web page to at least one call indicator device;
at least one call indicator device including:
a processor;
memory; and
a first communication port for downloading audio files from the remote server system; and
a second communications port configured to connect to a public switched telephone network (PSTN) landline;
the at least one call indicator device configured to:
receive at the first communication port the at least one selected audio file downloaded from the remote server system;
save the at least one audio file to the call indicator device memory;
detect an incoming landline call at the second communication port; and
select and play one or more received audio files saved in memory to indicate the incoming PSTN call.

14. The landline-telephone personalization system of claim 13 wherein the originator is compensated for downloads of the original audio file indexed to the originator.

15. The landline-telephone personalization system of claim 13 wherein the originator is compensated upon a threshold number of downloads of the original audio file indexed to the originator.

16. The landline-telephone personalization system of claim 13 wherein the remote server system indexes the original audio file to the file originator upon upload of the file.

17. The landline-telephone personalization system of claim 13 wherein the call indicator device plays a first audio file and a second audio file to indicate the incoming PSTN call at the second communications port.

18. A method for developing on line content for a call indicator device comprising:
storing an original audio file at a local computer;
registering an audio file originator in a remote server system;
uploading the original audio file from the local computer to an audio file archive in the remote server system;
indexing the uploaded original audio file to the registered originator;
presenting on a web page resident on the remote server system at least one uploaded original audio file available for download to the call indicator device;
a call indicator device user selecting at least one original audio file from the web page for download;
downloading the selected original audio file in the audio file archive to the call indicator device;
crediting the originator in the remote server system for each download to a call indicator device of the original audio file indexed to the originator; and
rewarding the originator as a function of the number of credits.

19. The method for developing on line content of claim 18 where rewarding the originator occurs after the number of credits reaches a threshold.

20. The method for developing on-line content of claim 18 where the reward includes access to audio files.

21. The method for developing on line content of claim 18 where the reward includes monetary remuneration.
